(19) United States
(12) Patent Application Publication
(10) Pub. No.: US 2026/0094193 A1
(43) Pub. Date: Apr. 2, 2026

(54) Systems and Methods for the Generation of a Comparative Data Structure using a Large Language Model

(71) Applicant: Google LLC, Mountain View, CA (US)

(72) Inventors: Bhavika Goyal, Redwood City, CA (US); Rushil Grover, San Jose, CA (US); Shahab Kamali, Mountain View, CA (US); Aidan Oldershaw, Montréal (CA); Senthil Hariramasamy, Mountain View, CA (US)

(21) Appl. No.: 18/902,513

(22) Filed: Sep. 30, 2024

(51) Int. Cl. G06Q 30/0601

(52) U.S. Cl. CPC G06Q 30/0629; G06Q 30/0627

(57) ABSTRACT

Systems and methods for the generation of a comparative data structure using a large language model. The method includes obtaining, by a computing system, input data comprising a user query and query context data; processing, by a large language model (LLM) operating on the computing system, the user query and the query context data to generate a set of search results; defining, by the LLM, a schema associated with a plurality of differentiators based on the user query, the query context data, and the set of search results; extracting, by the LLM, information associated with the plurality of differentiators from the set of search results; generating, by the LLM, a comparative data structure using the schema and the information associated with the plurality of differentiators; and comparing, by the LLM, the set of search results based on the information associated with the plurality of differentiators using the comparative data structure.

### FIELD

The present disclosure relates generally to systems and methods for the generation of a comparative data structure using a large language model.

### BACKGROUND

Existing comparison tools in the market often present content with excessive specificity, prioritizing individual items rather than the broader attributes and traits that users need during the mid-funnel stage of their decision-making process. The mid-funnel stage, also known as the consideration stage, is a stage where potential customers are aware of a brand and are considering making a purchase but are not ready to commit yet. This narrow focus can obscure the overall context and hinder users' ability to efficiently compare fundamental features and traits across various products. The excessive specificity in the existing tools stems from the comparison tool's approach to filtering and displaying data that has been sourced from various websites.

Accordingly, improved comparison tools are desired in the art. In particular, comparison tools which provide assistance to users in identifying and comparing generalized attributes that are relevant in the mid-funnel stage would be advantageous.

### SUMMARY

Aspects and advantages of embodiments of the present disclosure will be set forth in part in the following description, or can be learned from the description, or can be learned through practice of the embodiments.

In an exemplary aspect, the present disclosure provides for a method for the generation of a comparative data structure using a large language model. The method includes obtaining, by a computing system, input data comprising a user query and query context data; processing, by a large language model (LLM) operating on the computing system, the user query and the query context data to generate a set of search results; defining, by the LLM, a schema associated with a plurality of differentiators based on the user query, the query context data, and the set of search results; extracting, by the LLM, information associated with the plurality of differentiators from the set of search results; generating, by the LLM, a comparative data structure using the schema and the information associated with the plurality of differentiators; and comparing, by the LLM, the set of search results based on the information associated with the plurality of differentiators using the comparative data structure.

In an exemplary aspect, the present disclosure provides for a computing system, comprising: one or more processors; and one or more transitory or non-transitory computer-readable media storing instructions that are executable to cause the one or more processors to perform operations. The operations includes obtaining, by the one or more processors, input data comprising a user query and query context data; processing, by a large language model (LLM) operating on the one or more processors, the user query and the query context data to generate a set of search results; defining, by the LLM, a schema associated with a plurality of differentiators based on the user query, the query context data, and the set of search results; extracting, by the LLM, information associated with the plurality of differentiators from the set of search results; generating, by the LLM, a comparative data structure using the schema and the information associated with the plurality of differentiators; and comparing, by the LLM, the set of search results based on the information associated with the plurality of differentiators using the comparative data structure.

In an exemplary aspect, the present disclosure provides for one or more exemplary non-transitory computer-readable media storing instructions that are executable by one or more processors to cause a computing system to perform example operations. In some implementations, the exemplary operations can include obtaining, by the one or more processors, input data comprising a user query and query context data; processing, by a large language model (LLM) operating on the one or more processors, the user query and the query context data to generate a set of search results; defining, by the LLM, a schema associated with a plurality of differentiators based on the user query, the query context data, and the set of search results; extracting, by the LLM, information associated with the plurality of differentiators from the set of search results; generating, by the LLM, a comparative data structure using the schema and the information associated with the plurality of differentiators; and comparing, by the LLM, the set of search results based on the information associated with the plurality of differentiators using the comparative data structure.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is an exemplary block diagram of a system for the generation of a comparative data structure using a large language model in accordance with embodiments of the present disclosure;

FIG. 2 is an exemplary block diagram of a system for defining a schema associated with a plurality of differentiators in accordance with embodiments of the present disclosure;

FIG. 3 is an exemplary embodiment of a comparative data structure in accordance with embodiments of the present disclosure;

FIG. 4 is a flow chart diagram illustrating an example method for the generation of a comparative data structure using a large language model.

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure; and

FIG. 9 is a block diagram of an example networked computing system according to example implementations of aspects of the present disclosure.

### DETAILED DESCRIPTION

Generally, the present disclosure is directed to the development of a comparative data structure designed to enhance user decision-making by evaluating key attributes and traits across multiple content items. Existing comparison tools in the market often present content with excessive specificity, prioritizing individual items rather than the broader attributes and traits that users need during the mid-funnel stage of their decision-making process. The mid-funnel stage, also known as the consideration stage, is a stage where potential customers are aware of a brand and are considering making a purchase but are not ready to commit yet. This narrow focus can obscure the overall context and hinder users' ability to efficiently compare fundamental features and traits across various products. The excessive specificity in the existing tools stems from the comparison tool's approach to filtering and displaying data that has been sourced from various websites. Systems and methods for generating a comparative data structure are needed to assist users in identifying generalized attributes that are relevant in the mid-funnel stage. The present disclosure provides for improved systems and methods for filtering and comparing data that has been sourced from various websites by establishing a schema for identifying and comparing the key attributes associated with each content item.

Establishing the schema includes generating a structured representation of a plurality of differentiators of a product. This may include organizing the characteristics and traits of the product using a large language model (LLM) or an equivalent generative model. The LLM processes user queries to generate a refined set of search results by first filtering the queries according to predefined criteria and mapping them to a generalized product category to ensure alignment with broader product domains. Following this, the LLM identifies and organizes the key differentiators of the product into a structured schema, which serves as a comprehensive framework for categorizing and presenting these attributes in a coherent and user-friendly manner.

Defining the schema may involve identifying a plurality of differentiators associated with the product. The LLM may define the differentiators of the product by evaluating the contextual relationships between historical versions of product categories and user queries. The patterns that exist in these contextual relationships may be evaluated by the LLM to identify the plurality of differentiators associated with the product. For example, defining the schema might include categorizing the differentiators into groups such as performance metrics, features, pricing, while also specifying how these categories interrelate.

Utilizing the schema framework, the system extracts relevant attributes and features from each content item within the refined set of search results. To ensure compatibility with the comparative data structure, these attributes and features may undergo additional processing, which could include normalization to standardize data formats, ranking to prioritize the most relevant search results, and grounding to ensure data accuracy and relevance. Once processed, the attributes and features are then populated into the comparative data structure.

The technology of the present disclosure represents a significant advancement over existing comparison tools by leveraging the LLM to systematically refine and present key attributes and traits across multiple content items. Unlike conventional tools that often focus on highly specific details, this approach utilizes the LLM to categorize and filter user queries into generalized product domains, thereby enhancing the relevance and context of the comparative data. The establishment of the structured schema represents an improvement to the efficiency and accuracy of computing systems that are used to generate comparative information. Additionally, the integration of data processing techniques such as normalization, ranking, and grounding ensures that attributes are standardized into a format that is suitable for the comparative data structure. This methodology results in a more generalized and contextually relevant overview of products representing an improvement over existing comparison tools.

The improvements associated with the systems and methods discussed herein can be further understood with reference to the figures. Reference now is made to the figures, which provide example arrangements of computing systems, model structures, and data flows for illustration purposes only.

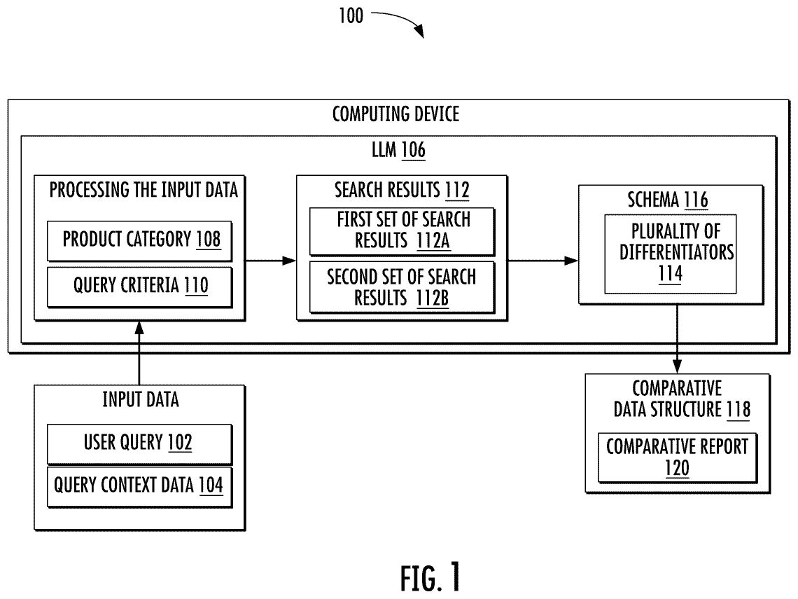

Referring now to the drawings, FIG. 1 illustrates an exemplary block diagram of a system for generating a comparative data structure using a large language model. System 100 can include a user query 102, query context data 104, a large language model (LLM) 106, product category 108, query criteria 110, set of search results 112a-b, schema 116, plurality of differentiators 114, comparative data structures 118, comparative report 120.

The operations include obtaining input data comprising a user query 102. As used in the current disclosure, a user query 102 refers to a request for information related to a specific product or service. The user query 102 could pertain to any product or service. In a non-limiting example, the user query 102 may be associated with products such as electronics, transportation, household goods, machinery, toys, clothing, jewelry, or any other type of product.

The user query 102 may be received from a user through various channels such as online forms, customer service emails, or live chat systems. Users typically submit their queries by entering text or selecting options that describe their request or issue.

The user queries 102 may range from generalized inquiries to highly specific requests. A generalized user query 102 might include search terms such as “Car” or “mid-size sedan,” which are broad in nature and pertain to wide categories of products. Alternatively, the user query 102 may also include queries that include requests for a specific product with specific attributes. For example, the user queries 102 may focus on a particular make, model, year, color, and condition of a vehicle, such as “2019 White Brand A Model B with less than 50,000 miles.”

System 100 is configured to receive query context data 104 associated with the user query 102. Query context data 104 refers to the contextual information associated with the user or the user query 102. Query context data 104 provides additional insight into the circumstances surrounding the user query 102. Query context data 104 may be used to interpret user queries 102 by considering the broader context in which they arise. Query context data 104 may include a range of information derived from the user's past interactions with the system 100.

Query context data 104 may encompass information about the user's previous interactions with the system 100. This may include previous searches conducted by the user, links that have been clicked, pages that have been visited, and other relevant actions or behaviors exhibited within the system. For example, suppose a user has frequently searched for details about a particular type of product or has navigated through multiple pages related to specific product categories 108. In that case, this historical engagement may be captured as query context data 104. By analyzing these previous interactions, the system can tailor responses more precisely to the user's current user query 102.

The query context data 104 may be generated by analyzing historical interactions with system 100. When a user submits a new query, the system leverages this accumulated context to enhance its understanding of the user's current needs and preferences. For instance, if a user who has previously shown interest in high-end electronics submits a query about the latest product releases, the system can infer that the user may be looking for premium options and tailor the response accordingly. This contextual information helps in refining the system's responses to be more aligned with the user's established interests and prior behaviors.

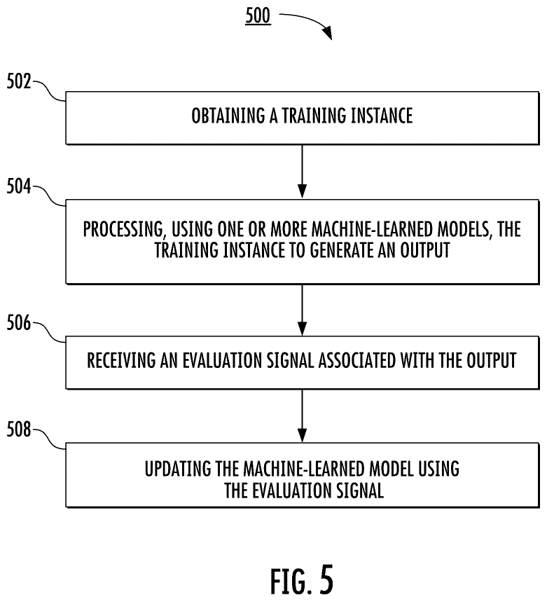

With continued reference to FIG. 1, System 100 includes a large language model (LLM) 106. As used in the current disclosure, a LLM 106 is a deep learning data structure that can recognize, summarize, translate, predict and/or generate text and other content based on knowledge gained from massive datasets. Large language models 106 may be trained on large sets of data. Training sets may be drawn from diverse sets of data such as, as non-limiting examples, books, websites, advertising, content items, structured data, unstructured data, electronic records, and the like. In an embodiment, an LLM 106 may include one or more architectures based on capability requirements of an LLM. Architecture choice may depend on a needed capability such as generative, contextual, or other specific capabilities. LLM 106 is discussed in greater detail herein below with reference to FIGS. 5-9.

With continued reference to FIG. 1, the system is configured to perform operations that include processing, by the large language model (LLM) 106, the user query 102, and the query context data 104. Processing the user query 102 and the query context data 104 parsing the text associated with the user query 102. This may include tokenizing the user query 102 by breaking down the query into individual components, such as words, phrases, sub-words, and key terms. The components that are extracted from the user query 102 may include product names, brand names, product types, descriptive terms, and the like.

Tokenization of the user query 102 may be done with the goal of converting the raw text of the user query 102 into a format that the LLM 106 can effectively evaluate. The LLM 106 may then apply natural language processing techniques to the tokenized text of the user query 102 to determine the semantic meaning of the text. Based on this semantic meaning, the user query 102 may be further processed. This may include mapping the user query 102 to a product category 108 or comparing the user query 102 to a set of query criteria.

In an embodiment, processing the user query 102 and the query context data 104 may include mapping the user query 102 to a product category 108 based on the query context data 104. As used in the current disclosure, the product category 108 refers to a set of products that are grouped together based on similar characteristics. Mapping the user query 102 to the product category 108 may be used to organize the user query 102 into distinct groups associated with products. These products share common characteristics, attributes, and/or features. In a non-limiting example, the product category 108 associated with an “Electric Vehicle” may include user queries 102 for specific electric vehicle product lines. In an additional non-limiting example, if the user query 102 states “Boxy Gold Watches” the system may map this query to a more generalized product category 108 such as “Men's Watches” or “Gold Watches.” Mapping the user query 102 to the product category 108 may be done to generalize the specific details of the user query 102 to align with broader product categories. This may be done with the goal of allowing the system to perform a more generalized search for the product that is associated with the user query 102. This generalization may be used to help the users broaden their search while in the mid-funnel stage.

The processor may map the user query 102 to product category 108 by analyzing both the user query 102 and the query context data 104. This may be done to identify any key terms that are associated with the user query 102. The key terms may be terms that are used within the user query 102 or terms that are commonly associated with the terms within the user query 102. In an embodiment, the key terms may be broader, narrower, or synonymous with the product category 108. The key terms may be used to associate the user query 102 with a known product or category of products. In a non-limiting example, if the user query 102 states the search term, “basketball shoes” this term may be mapped to the key term “Sneakers.” The query context data 104 may be used to provide context to the LLM 106 to interpret the intent behind the user query 102. The correlation between the key term and the user query 102 may be determined based on the query context data 104. This may include using the user's previous interactions with the system to identify the semantic context of the user query 102. The LLM 106 may consider synonyms, related terms, and historical trends to identify the key term.

Each key term may be a member of at least one query cluster. A query cluster is a group of user queries 102 or key terms that are associated with the one or more product categories 108 based on their semantic meaning. Query clusters are formed by analyzing the semantic relationships between groups of user queries 102 and/or key terms to identify their commonalities. Commonalities between the user queries 102 and/or key terms may be based on the semantic relationship between the group of terms. This may include an evaluation of whether the terms are synonymous, closely related, frequently used together, and the like. In a non-limiting example, the group of user queries 102 comprising “Rugged shoes” and “Steel Toe” may be mapped to the query cluster associated with “Boots” or “Work Boots.” The query cluster associated with work boots may be a subset of the query cluster associated with boots and footwear. The LLM 106 may evaluate the query context data 104 to determine the semantic context between the group of user queries 102. Based on the selected semantic context the LLM 106 may be configured to decide the level of granularity that should be associated with the query cluster. Within the context of the previous example, LLM 106 may determine the semantic context of the user queries 102 to determine that the queries are related to protective footwear rather than other potential definitions of the search term, such as a wooded area or hockey team. By assigning the user queries 102 or key terms to at least one query cluster, system 100 may become more efficient when processing the user queries 102. This process may be implemented using any algorithms or machine learning models discussed herein.

In an embodiment, if the extracted components from the user query 102 do not align with a known query cluster, the system may associate the user queries 102 with the closest related key term and then identify the query cluster based on the semantic relationship between the user queries 102 and the key terms. System 100 may have a preexisting database with a plurality of exemplary components, user queries 102, and key terms. The database may additionally include information about the semantic relationship between the plurality of exemplary components, user queries 102, key terms, product categories 108, product lines, and the like. System 100 may use these semantic relationships to map the user queries 102 to a known term such as the key terms, product categories 108, and product lines.

Once the system 100 has assigned the user query 102 to the one or more query clusters, it may map the query cluster to the corresponding product category 108. Each query cluster is associated with at least one product category. This mapping process may involve selecting the product category 108 that matches the intent of the user's query based on the key terms that are associated with the query cluster. In an embodiment, if user query 102 or key term belongs to multiple query clusters, user query 102 or key term may be mapped to multiple product categories.

The LLM 106 may process the information associated with the product category 108 to identify a plurality of product lines. As used in the current disclosure, a product line is a group of related products that are offered by a company under a single brand. The products in the product line may share common features and have similar uses, but these products have slight differences to cater to different segments of the market. These differences may include differences in size, color, features, prices, storage, and the like. The product line provides a range of options that meet the different needs, preferences, and budgets of the consumer. In a non-limiting example, a company may offer a product line of smartphones. Each smartphone in the product line may have varying screen sizes, storage capacities, camera qualities, and price points. Product lines may be associated with query clusters or product categories 108. For example, a query cluster that describes athletic shoes may be associated with a product line of basketball shoes.

In an embodiment, processing the user query 102 may include comparing the user query 102 to a set of query criteria 110. As used in the current disclosure, query criteria 110 are rules that are used to ensure that the user query is within a predetermined scope. Query criteria 110 may be used to filter and/or alter the user query 102 to ensure that it is within the predetermined scope. This may include flagging, removing, or modifying queries that are tied to a geographic location, unrelated to a product or service, have incorrect specificity, and the like.

The query criteria 110 may include requirements that the user query 102 be free from restrictions centered around locality. The locality restriction may require that the user query 102 does not state that the user is looking for a product from a specific geographic location, such as locations associated with a geofenced area, zip code, area code, city, state, county, country, voting district, and the like. This may also include user queries 102 that are associated with a local merchant. The goal of the locality restriction may be to keep the user queries 102 broad so that they are not limited according to geography. This is useful in the mid-funnel stage because the system may prioritize finding the type of product or the desired attributes of the product rather than a location associated with the product. In a non-limiting example, the locality restriction may be used to filter/modify a user query 102 that states “Kitchen Table Near Me.” The system 100 may modify the user query 102 based on the locality restriction to only search for a “Kitchen Table.”

The query criteria 110 may include requirements that the user query 102 adheres to a commerciality requirement. The commerciality requirement may be used to ensure that the user query 102 is directly or indirectly related to a product or a service. The commerciality requirement may be used to ensure that each user query 102 has commercial intent. User queries 102 that do not have a clear connection to a product or service may be filtered, removed, or modified by the LLM 106 to adhere to the commerciality requirement. This may include user queries 102 that are strictly informational because they only seek knowledge or information but lack the commercial intent. Strictly informational queries may even seek information related to a product or service. Exemplary user queries 102 that fail to adhere to the commerciality requirement may include queries such as “Pizza Palace Phone Number” or “Address for The Bike Shop.” Alternatively, user queries 102 that simply ask a question but also have commercial intent may adhere to the commerciality requirement. These user queries 102 may ask a question about a characteristic, quality, or price point associated with a product. Query context data 104 be used to determine whether each user query 102 includes commercial intent or is strictly informational. Exemplary user queries 102 that adhere to the commerciality requirement may include queries such as “How much do sneakers cost?”

The query criteria 110 may include requirements that the user query 102 adheres to a specificity requirement. The specificity requirement may require that each user query 102 be related to a product or a category of product. If a user query 102 is too broad or too generalized it may fail to adhere to the specificity requirement. This may include user queries 102 that do not mention a product, brand, product category, product line, characteristics of a product, and the like. In a non-limiting example, user queries 102 that fail to adhere to the specificity requirement may include “gift ideas” or “Mother's Day present.”

With continued reference to FIG. 1, the system is configured to perform operations that include processing, by the large language model (LLM) 106, the user query 102 and the query context data 104 to generate a set of search results 112. The set of search results 112 refers to a collection of websites that have been curated according to the user query. This collection of websites may include various content items that were generated in response to the user query 102. The set of search results 112 may be designed to address the specific needs and preferences indicated by the user's request and contextual background. Each entry within the set of search results 112 may be selected based on its relevance to the query and/or its alignment with the user's past interactions and preferences. The nature of the set of search results 112 can vary depending on the type of user query 102 and the contextual information associated with the query. For instance, if the user query 102 pertains to a specific product, such as “noise-canceling headphones,” the set of search results 112 might include content items, product listings, reviews, comparisons, and specifications related to noise-canceling headphones.

In an embodiment, the search results 112 may be sourced from a diverse array of websites. These search results 112 are configured to be tailored to address the specific needs and preferences indicated by the user query 102 and the query context data 104. This set of search results 112 may be generated through a process wherein the processor is configured to conduct a search across multiple websites to locate and retrieve relevant content items. These websites may be indexed within an index data structure. This index data structure is a repository that has been created by scraping a large amount of data from various websites, databases, e-commerce platforms, digital libraries, content items, and the like. This index data structure is configured to store the information in a manner that will allow for the efficient retrieval of the data objects.

System 100 may query the index data structure using the user query 102 and the query context data 104. This may be done to identify content items or other search results that match with the product category 108, product line, or user query. This may be done by using a semantic matching process to identify entries within the index data structure that have a similar semantic meaning to the user query 102. In a non-limiting example, if the user query 102 states “fuzzy house shoes” the search results 112 may include entries that are related to slippers, flip flops, or other forms of slide-on shoes. The semantic matching process may be paired with a weighted index to select the entries within the set of search results. When using the weighted index, the system evaluates the frequency with which keywords and phrases appear within the website or content item. The more that a given keyword or phrase appears within the text, the more likely it is that the entry will be selected to be in the set of search results.

System 100 may perform operations that include ranking each search result within the set of search results 112 based on the information associated with the plurality of differentiators 114. System 100 may rank each search result within the set of search results 112 according to the relevance to the user query 102. This may include an assessment of how well each search result matches the user query 102 according to its semantic relevance and the content of the search results 112. The more terms of semantic relevance that are found within a given search result the higher that search result may be ranked.

In a non-limiting example, the user query 102 includes the statement “65” Flat Screen TV.” The processor may identify search results 112 that include phrases related to large televisions. Search results 112 that include phrases related to large televisions may be ranked higher than search results without those phrases. These phases may include terms like “OLED,” “Smart TV,” “Ultra HD TV,” physical dimensions, and the like. Additionally, the LLM 106 may rank the search results 112 according to the content. This may include searching for key terms that are associated with the differentiators 114. If these key terms are low in number or missing, they may negatively affect the ranking of the search results. With reference to the above-mentioned example, if the search results are silent regarding the size of the television they may fall in the rankings. Alternatively, search results that provide desired information that is related to the differentiators will rise in the rankings.

In some cases, system 100 may select a subset of search results from the set of search results 112 based on the ranking. This may be done by comparing the ranked search results to a relevance threshold. The relevance threshold is a threshold to quantify the minimum level of similarity between the search result and the user query 102. This relevance threshold may act as a filter to remove the less relevant search results from the set of search results 112. After the set of search results 112 has been filtered according to their relevance, system 100 may select a group of the most relevant search results to form the subset of search results. This may be evaluated according to a numerical score, the number of key terms present within the search results, the content of the search results, and the like.

Once the search results 112 are selected they may further be refined using an iterative process. In an embodiment, the set of search results 112 may include multiple iterations of search results. This may include a first set of search results 112a, a second set of search results 112b, a third set of search results, up to and including a nth set of search results. Through each iteration of search results system 100 may be configured to refine the set of search results 112 based on new information that is received from the previous iteration of search results.

In a non-limiting example, the first set of search results 112a may be used to produce search results based on the user query 102 and the query context data 104. These search results may be used to generate a more refined set of search results in the second set of search results 112b. The first set of search results 112a may be used to represent a baseline set of results to match the user query 102 to a set of search results. The LLM 106 may evaluate the first set of search results 112a to identify how well the search results captured the user's intent. The first set of search results 112a may be evaluated within the context of the processed user query 102 and query context data 104. This may include extracting, by the LLM 106, the information associated with the processed user query 102 from the first set of search results 112a. Additionally, the LLM 106 may then refine the results by removing undesirable content such as irrelevant content or outdated content. With the added context from the evaluation of the first set of search results 112a, the LLM 106 may then generate a second set of search results 112b. This process may be iteratively repeated until the search results 112 meet a relevance threshold that is set by the LLM 106.

With continued reference to FIG. 1, the LLM 106 may be used to identify the plurality of differentiators 114 based on the product category 108 and the query context data 104. As used in the current disclosure, a differentiator is a characteristic of a product or product category 108. The differentiators 114 are characteristics of a product that will likely influence the user to select one product over another. The differentiators 114 are used to highlight the characteristics that matter the most to the users' needs. Essentially, the differentiators 114 represent aspects of the product that set it apart from competing products. Exemplary differentiators 114 may include characteristics like price, quality, features, specifications, designs, reviews, and the like. The LLM 106 may use the query context data 104 to select the plurality of differentiators 114. The query context data 104 may provide insights into what the user relieves are the most relevant traits of the product.

In an embodiment, the LLM 106 may use the query context data 104 in conjunction with the product category 108 to identify the plurality of differentiators 114. The LLM 106 may evaluate the contextual relationships between historical versions of the product category 108 and the query context data 104 to identify the current differentiators 114. The LLM 106 may identify and evaluate the patterns that exist in these contextual relationships to identify common themes that exist between a user's query context data 104 and the product categories 108. Each product category 108 may include a set of categories associated with the characteristics of the product. The categories may be generated based on the identified themes between historical differentiators 114 of the product category 108. Each set of categories may be tailored to its respective product category 108. The set of categories may include exemplary traits associated with the product category 108 like durability, specifications, features, price, along with other factors that define the product's value and utility to the user. The query context data 104 may be used to provide clues to the most desired traits by the user. In a non-limiting example, if the query context data 104 provides information that the user has bought several digital cameras within a given time period for their personal use. The system can infer from the previous searches that characteristics such as durability, price point, and image quality are the key differentiators 114 for the product category 108.

In some cases, the plurality of differentiators 114 may be ranked based on the query context data 104. This may mean that the plurality of differentiators 114 are ranked according to their relevance to the user query 102. Differentiators 114 that are more contextually relevant to the user may be ranked favorably. Alternatively, differentiators 114 that are less contextually relevant to the user may be ranked less favorably. The contextual relevance of each differentiator 114 by analyzing the query context data 104 that is associated with the product category 108 or product line. This may include an evaluation of the historical relevance of similar queries where users had similar contextual data. Additionally, the ranking may consider factors such as recent trends or industry standards.

With continued reference to FIG. 1, the system is configured to perform operations that include defining, by the LLM 106, a schema 116 associated with a plurality of differentiators 114 based on the user query 102, the query context data 104, and the set of search results 112. As used in the current disclosure, schema 116 refers to the organization of data within the data structure. Defining the schema 116 may include determining a structured representation of the plurality of differentiators 114. This may include organizing the characteristics and traits of the product category 108 or product. The schema 116 provides a structure to store, retrieve, and compare data between multiple products that each have one or more unique characteristics. The schema 116 may be used to compare the characteristics of products across various product lines, brands, and merchants with different features, qualities, and price points.

In an embodiment, defining the schema 116 may include selecting a plurality of fields associated with a plurality of differentiators 114. These fields may be used to display values associated with one or more characteristics of the differentiators 114. Each field may be used to convey values pertaining to one or more characteristics of the product category 108. These fields may be configured to include various data types, such as numerical data, categorical data, Boolean data, textual data, and the like. Fields depicting numerical data may be used to convey differentiators 114 that are associated with numerical data such as price, miles per gallon, charging time, battery life, and the like. Fields depicting categorical data may be used to convey differentiators 114 that are associated with defined categories such as brand, color, material, and the like. Fields depicting textual data may be used to convey text-based differentiators 114 such as product descriptions or reviews.

In a non-limiting example, the differentiators 114 associated with electric vehicles may include driving range. The schema 116 associated with this differentiator 114 may include a number of fields associated with the driving range of the vehicle. This may include fields associated with the battery of the vehicle and that battery's capacity. Additionally, this schema 116 may include information associated with the charging infrastructure surrounding the user. Based on the differentiator 114 and the query context data 104 the LLM 106 will define the schema 116 by selecting the most relevant fields to the user.

These fields may contain information from a plurality of content items that have been sourced from the search results 112. Based on the selected content items the LLM 106 may determine a plurality of differentiators 114 and the schema 116. These content items may be websites that are associated with a merchant who is selling the desired product or goods.

In some cases, the fields associated with the schema 116 may be selected according to the ranking of the plurality of differentiators 114. This may be done to ensure that the most contextually relevant characteristics of the product are reflected within the schema 116.

With continued reference to FIG. 1, the system is configured to perform operations that include extracting, by the LLM, information associated with the plurality of differentiators 114 from the set of search results 112. Information associated with the plurality of differentiators 114 may include data related to the characteristics of the product. This may include information associated with the product or product category 108 such as information about the physical attributes, technical specifications, performance, design, price, reviews, safety, environmental impact, and the like. This information may be sourced from the websites, content items, and product listings that are within the set of search results 112.

Once the LLM 106 has determined the plurality of differentiators 114, the LLM 106 may then extract information associated with the plurality of differentiators 114 from the set of search results 112. This information may take on various forms, such as unstructured text and image data. The LLM 106 may process both the unstructured text and image data to get it in a form that is suitable for the desired schema 116. Once the information has been processed, the LLM 106 may then isolate the text associated with the plurality of differentiators 114. The comparative data structure 118 may be populated with these values that are extracted from the set of search results 112 or the subset of search results.

In an embodiment, the system performs operations that include generating a smart prompt based on the user query 102, location data associated with a user, and information associated with the plurality of differentiators 114. As used in the current disclosure, a smart prompt is a specialized query designed to interact with the LLM 106. The smart prompt is generated to maximize the performance of the LLM 106 by using specific wording, structure, and contextual information. The smart prompt includes key details and context that can be used to guide the LLM 106 to provide a more refined answer. The smart prompt might provide additional information to the LLM 106 regarding which portion of the prompt to focus on, the length and format of the response, the key attributes, and the like. In a non-limiting example, the user query states, “Desk for a Home Office.” The processor may be configured to generate an exemplary smart prompt stating “Find a standing desk that is at least 4 ft long, within at least 50 miles of the Atlanta metropolitan area.” The LLM 106 will provide a more refined response due to the additional context of the smart prompt.

In some cases, the smart prompt may be tailored to assist the LLM 106 in performing various operations. These operations may include but are not limited to generating a set of search results 112, defining the schema 116, generating the comparative data structure 118 or comparative report 120, or any other operations discussed within the current disclosure.

With continued reference to FIG. 1, the system performs operations that include generating a comparative data structure 118 using the schema 116 and the information associated with the plurality of differentiators 114. As used in the current disclosure, the comparative data structure 118 is a data structure that is used to organize data for a systematic comparison of multiple products with various characteristics. The comparative data structure 118 includes multiple values across various fields, each of which holds specific information. Each field within the comparative data structure 118 may represent a distinct category of information associated with the plurality of differentiators 114. For instance, the comparative data structure 118 might include a schema 116 that calls for fields associated with brand, price, product name, physical characteristics, dimensions, color, reviews, specifications, performance data, and the like. Each of these fields may contain values that are used to quantify the product in terms of the characteristics highlighted by the field. In a non-limiting example, the comparative data structure 118 associated with the product category 108 “Mid-Size SUV” may include a plurality of fields that are used to describe a mid-size SUV, such as gas mileage, safety ratings, number of seats, and the like.

In an embodiment, the comparative data structure 118 may include the comparative report 120. As used in the current disclosure, the comparative report 120 is a report used to compare products. The comparative report 120 may be used to define each field that is required by the schema 116. This may include a description of each characteristic of the product that is represented by the schema 116. For example, if the schema 116 calls for fields associated with the product category 108 “Smartphone.” The fields are used to describe characteristics such as battery life, screen size, camera quality, and the like. The comparative report 120 may explain why each field was chosen, such as “Battery life is a quantification of the amount of time the smartphone can operate before it needs to be recharged.” The comparative report 120 may also include a description of why these fields are relevant to the user, such as “Based on your historical smartphone usage, you would require a battery life of at least eight hours.”

In some cases, the comparative report 120 may be used to analyze the content of the comparative data structure 118. This may include evaluating the products based on the provided schema 116. The comparative report 120 may describe why a first product is superior/inferior to a second product based on the information provided by the comparative data structure 118. For example, if the comparative data structure 118 compares four separate products across four fields, the comparative report 120 may explain the pros and cons of each product within a given field. This may include a direct comparison of the characteristics represented by the differentiators 114.

The LLM 106 may generate the comparative report 120 based on the values that are extracted from the set of search results 112 or the subset of search results. These values may be compared against each other and industry standards to generate the comparative report 120. This may include analyzing the key attributes of the product as described by the schema 116. The LLM 106 then compares these key attributes across the multiple products represented in the comparative data structure 118 and industry standards to evaluate the standing of each product. In some cases, the LLM 106 may highlight features that deviate from the industry standards. For example, if the industry standard is a minimum 7-hour battery life, and one product has a 4-hour battery life the LLM 106 may bring this deficit to the user's attention.

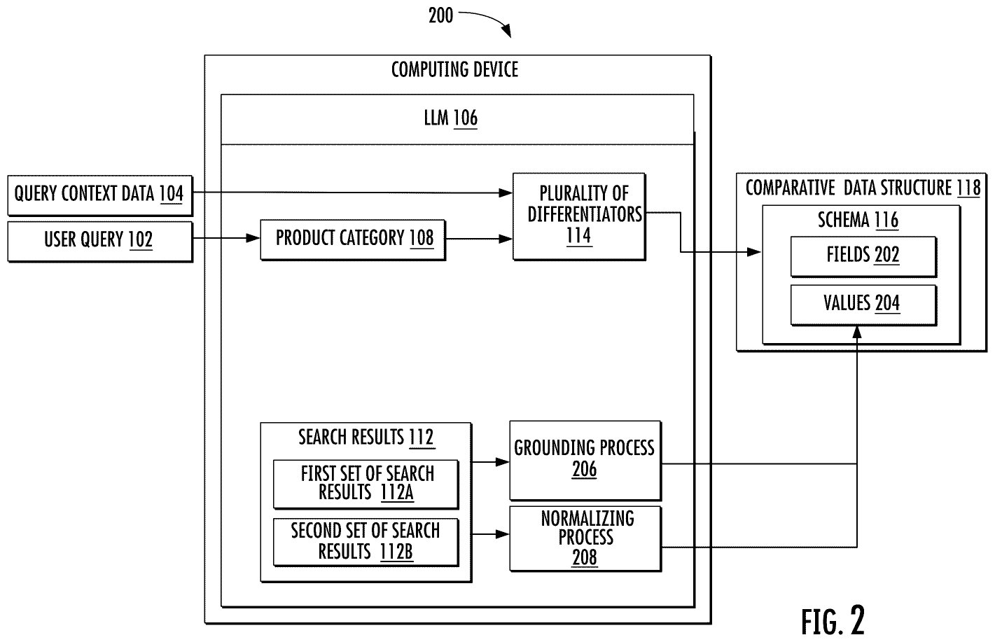

Referring now to FIG. 2, an exemplary block diagram of a system for defining a schema associated with a plurality of differentiators in accordance with embodiments of the present disclosure. FIG. 2 includes fields 202, values 204, grounding process 206, and normalizing process 208. The fields 202 and values 204 may be the same or substantially similar to the fields and values that were discussed in FIG. 1.

In an embodiment, generating the comparative data structure 118 may include initializing the comparative data structure and populating the comparative data structure 118 with the information associated with the plurality of differentiators. Populating the comparative data structure 118 may include populating the fields 202 with the values 204 that were extracted from the set of search results 112 or the subset of search results. In some cases, this may include extracting image data from the set of search results 112 and populating the image data into a comparative data structure 118.

Generating the comparative data structure 118 may include grounding the information associated with the plurality of differentiators 114 using a grounding process 206. As used in the current disclosure, a grounding process refers to a process by which a machine learning model, such as LLM 106, ensures that its response to a query is grounded in real-world data. The grounding process 206 may be used to validate values 204 that are produced by the LLM 106.

The grounding process 206 may include a data-driven approach where the values 204 associated with the differentiators 114 are cross-referenced against real-world data sources. These sources may include real time values that have been extracted from active websites, manufacturer databases, or other up-to-date sources. The LLM 106 extracts values 204 that are associated with the differentiators 114 from these sources. For example, if a differentiator relates to the price of a product, the grounding process 206 may be used to validate the pricing data against data that has been harvested from an active website.

Once the real-world values have been extracted, the grounding process 206 may compare these values to the values 204 that were produced by the LLM 106. In cases where discrepancies arise between the extracted real-world values and the values 204 generated by the LLM 106, the grounding process may prioritize the data that has been extracted from the active websites. The grounding process 206 may be used as a filter to remove any ungrounded values from the comparative data structure 118. After the ungrounded values have been filtered, the LLM 106 may proceed to populate the comparative data structure 118 with the grounded values.

Generating the comparative data structure 118 may include normalizing the information associated with the plurality of differentiators 114 based on the schema 116. As used in the current disclosure, normalization process 208 is a process that is used to standardize data into a common format. The normalization process 208 may be used to convert the information associated with the plurality of differentiators 114 into a set of values 204 that have a uniform format across a given field 202. As data regarding the plurality of differentiators 114 may originate from various sources and in varying formats, the normalization process 208 systematically converts this data into consistent units, formats, and terminologies under the schema 116.

The normalization process 208 may be used to normalize the differences in characteristics such as price, weight, terminology, units of measurement, features, and specifications. For example, if pricing data is presented in several currencies across various search results 112, the normalization process 208 may convert the pricing data into the single currency that is commonly associated with the user. Similarly, data pertaining to the dimensions of a product may be converted into a common unit of measurement.

In an embodiment, the normalization process 208 may be used to address gaps or inconsistencies in the data. In a non-limiting example, if search results 112 are missing portions of the description, the normalization process 208 may address this by referencing additional data sources or by applying inferred values based on known information. In some cases, these additional sources may be identified in a manner similar to the grounding process 206. This may mean that the missing values and inconsistencies in the data may be addressed using real-world values that have been extracted from an active website. This may be done to ensure that all the values within the comparative data structure 118 are fully populated with values 204 associated with differentiators 114.

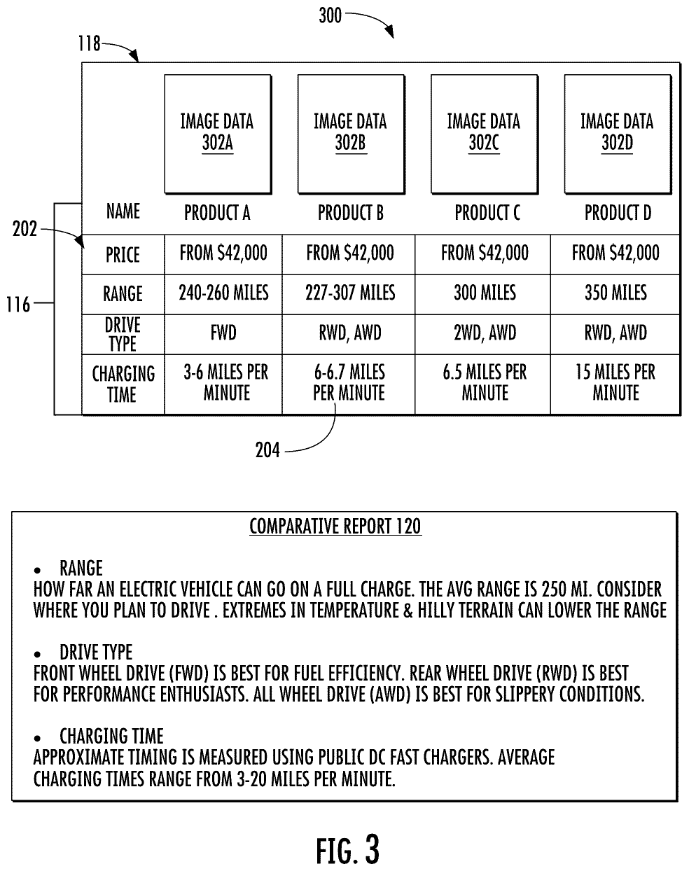

Referring now to FIG. 3, an exemplary embodiment of a comparative data structure in accordance with embodiments of the present disclosure.

FIG. 3 depicts an exemplary embodiment of a comparative data structure 118 associated with an electric vehicle. The comparative data structure 118 is composed of a schema 116 that organizes and presents a set of differentiators 114 pertaining to the electric vehicle. The differentiators 114 represent specific characteristics or attributes that are deemed most relevant to the user. These differentiators 114 may be selected based on contextual relevance derived from a user query 102 and corresponding query context data 104.

The process of generating the schema 116 involves the identification and selection of a set of fields 202 associated with the differentiators 114. The field 202 corresponds to specific characteristics of the electric vehicle. These characteristics are linked to the differentiators 114.

The fields 202 of the schema 116 are selected based on their relevance to the user query 102 and the query context data 104. These fields 202 may be selected based on their relationship to a set of ranked differentiators 114. The LLM 106 may rank these differentiators 114 based on their contextual significance. This ranking process may consider various factors, including the frequency of historical differentiators in past user queries, the user's known preferences from the query context data 104, or the relevance of specific differentiators 114 to the current market. For example, if the user has previously shown a preference for vehicles with high fuel efficiency, differentiators related to energy consumption or battery life may be ranked higher in the resulting schema 116.

Based on the selected schema 116, the LLM 106 may be used to identify and rank a set of search results 112. The LLM 106 may process the search results 112 to identify values 204 associated with the differentiators 114. This may include an analysis of the textual and image data 302a-d within the search results. This analysis may include the use of natural language processing techniques to match the relevant differentiators 114 in the schema 116 with the corresponding attributes of the electric vehicles described in the search results 112. For instance, if range, charging speed, and price are the highest-ranked differentiators, the LLM 106 filters the search results 112 to identify information sources that address these characteristics in the context of the electric vehicles. Search results 112 that are contextually relevant and include content that is aligned with the prioritized differentiators may be ranked higher.

Once the LLM 106 has identified and ranked the search results 112, the LLM 106 may proceed to harvest values 204 from the identified search results 112. These values 204 correspond directly to the fields 202 in the schema 116. For each field 202, the LLM 106 locates values 204 that match the selected differentiators 114. For example, if the schema includes a field 202 for “maximum range,” the LLM 106 may extract the exact values 204 from the search results associated with the range of the vehicle. These values may then be a “charging time,” the LLM 106 extracts and records the relevant data from the search results. In additional non-limiting example, if the schema 116 includes a field 202 for images of the vehicle, the LLM 106 may extract the exact image data 302a-d from the search results 112 and populate this data into the comparative data structure 118

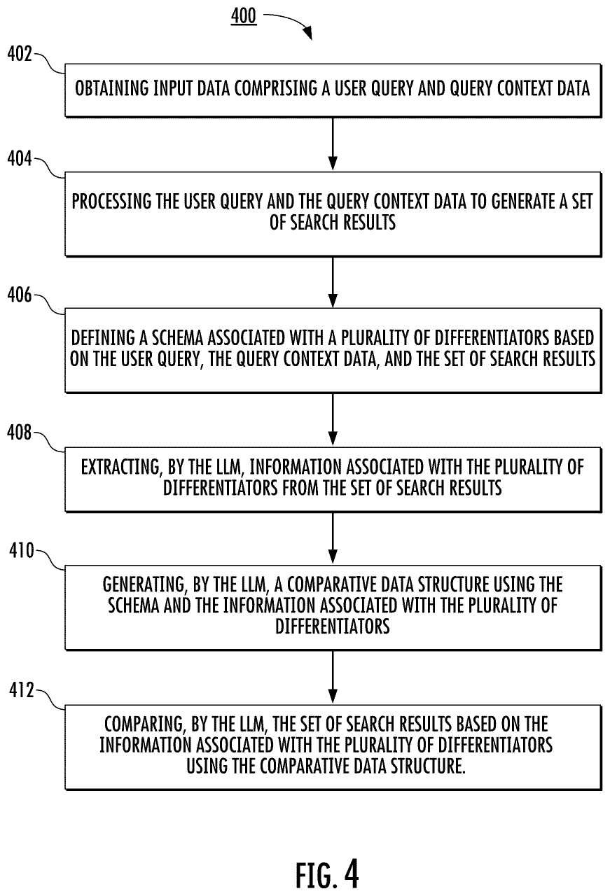

Referring now to FIG. 4, a flowchart of a method 400 for the generation of a comparative data structure using a large language model.

At step 402, the method includes obtaining, by a computing system, input data comprising a user query and query context data. Query context data may encompass information about the user's previous interactions. This may include previous searches conducted by the user, links that have been clicked, pages that have been visited, and other relevant actions or behaviors exhibited within the system.

The query context data 104 may be generated by analyzing historical interactions with system 100. When a user submits a new query, the system leverages this accumulated context to enhance its understanding of the user's current needs and preferences. For instance, if a user who has previously shown interest in high-end electronics submits a query about the latest product releases, the system can infer that the user may be looking for premium options and tailor the response accordingly. This contextual information helps in refining the system's responses to be more aligned with the user's established interests and prior behaviors.

At step 404, the method includes processing, by a large language model (LLM) operating on the computing system, the user query and the query context data to generate a set of search results. In an embodiment, processing the user query comprises mapping the user query to a product category based on the query context data. Mapping the user query to the product category may further include: assigning, using the LLM, the user query to at least one query cluster of a plurality of query clusters based on the query context data; and mapping, using the LLM, the user query to the product category based on the assignment. In an additional embodiment, processing the user query comprises comparing the user query to a set of query criteria.

In some embodiments, identifying the set of search results may further include: identifying, by the computing system, a first set of search results based on the user query and the query context data; extracting, by the LLM, information associated with the processed user query from the first set of search results; and generating, by the computing system, a second set of search results based on the information associated with the processed user query.

At step 406, the method includes defining, by the LLM, a schema associated with a plurality of differentiators based on the user query, the query context data, and the set of search results. In an embodiment, defining the schema associated with the plurality of differentiators may further include defining the schema based on the plurality of product lines. Defining the schema may further include identifying, using the LLM, the plurality of differentiators based on the product category and the query context data.

In some cases, defining the schema associated with the plurality of differentiators may include ranking, by the LLM, the plurality of differentiators based on the query context data; and defining, by the LLM, the schema associated with the plurality of differentiators based on the ranking.

At step 408, the method includes extracting, by the LLM, information associated with the plurality of differentiators from the set of search results. In an embodiment, extracting the information associated with the plurality of differentiators may further comprise, by the LLM, each search result within the set of search results based on the information associated with the plurality of differentiators. In some cases, extracting the information associated with the plurality of differentiators may further include selecting, by the LLM, a subset of search results from the set of search results based on the ranking; and extracting, by the LLM, information associated with the plurality of differentiators from the subset of search results.

At step 410, the method includes generating, by the LLM, a comparative data structure using the schema, and the information associated with the plurality of differentiators. In an embodiment, generating the comparative data structure comprises initializing, by the LLM, the comparative data structure; and populating, by the LLM, the comparative data structure with the information associated with the plurality of differentiators. In some cases, generating the comparative data structure may comprise grounding, by the computing system, the information associated with the plurality of differentiators using a grounding process. Generating the comparative data structure may include normalizing, by the computing system, the information associated with the plurality of differentiators based on the schema.

At step 412, the method includes comparing, by the LLM, the set of search results based on the information associated with the plurality of differentiators using the comparative data structure.

In an embodiment, generating the comparative data structure may include extracting, by the computing system, image data associated with the set of search results; and populating, by the computing system, the comparative data structure with the image data.

In some embodiments, the method may further include generating, by the computing system, a smart prompt based on the user query, location data associated with a user, and information associated with the plurality of differentiators; and identifying, by the LLM, the set of search results based on the smart prompt.

In other embodiments, the method may further include generating, by the LLM, a comparative report based on the information associated with each differentiator of the plurality of differentiators.

FIG. 5 depicts a flowchart of a method 500 for training one or more machine-learned models according to aspects of the present disclosure. For instance, an example machine-learned model can include the LLM 106.

One or more portion(s) of example method 500 can be implemented by a computing system that includes one or more computing devices such as, for example, computing systems described with reference to FIGS. 1-9. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-supervised or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be back propagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

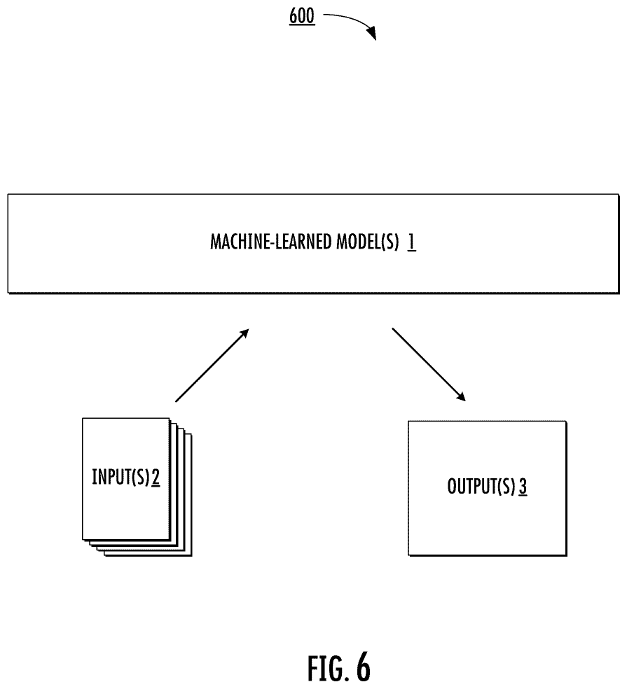

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree-based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of LLM 106 and/or any other machine-learning model mentioned herein.

Although various features, variations, and implementations described below are described with respect to machine-learned model(s) 1, it is to be understood that such features, variations, and implementations are to be understood as described with respect to LLM 106 and/or any other machine-learning model mentioned herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully connected layers).

Machine-learned model(s) 1 can employ a mixture-of-experts structure. See, e.g., Zhou et al., Mixture-of-Experts with Expert Choice Routing, ARX1v:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing the quantity of operations performed for processing a given input compared to a densely activated model. In this manner, for instance, the expressive and interpretive power of a high-parameter-count model can be achieved with more computationally efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

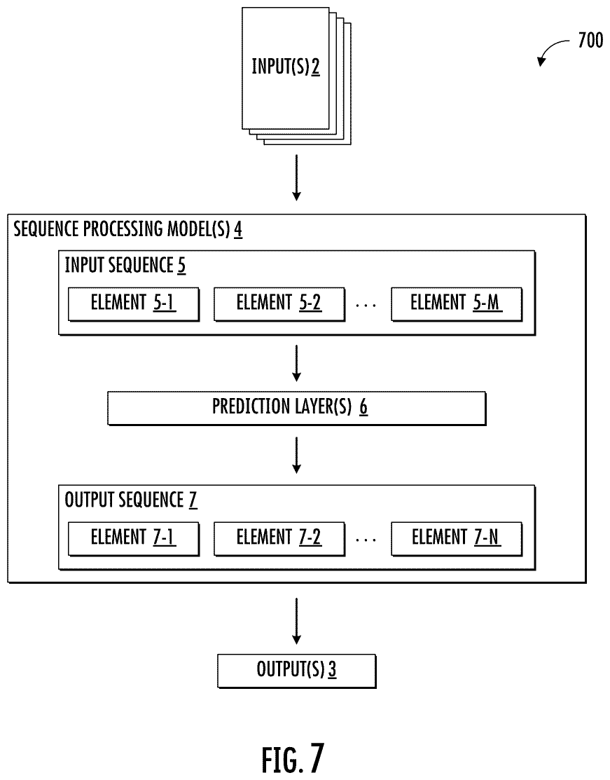

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressive. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

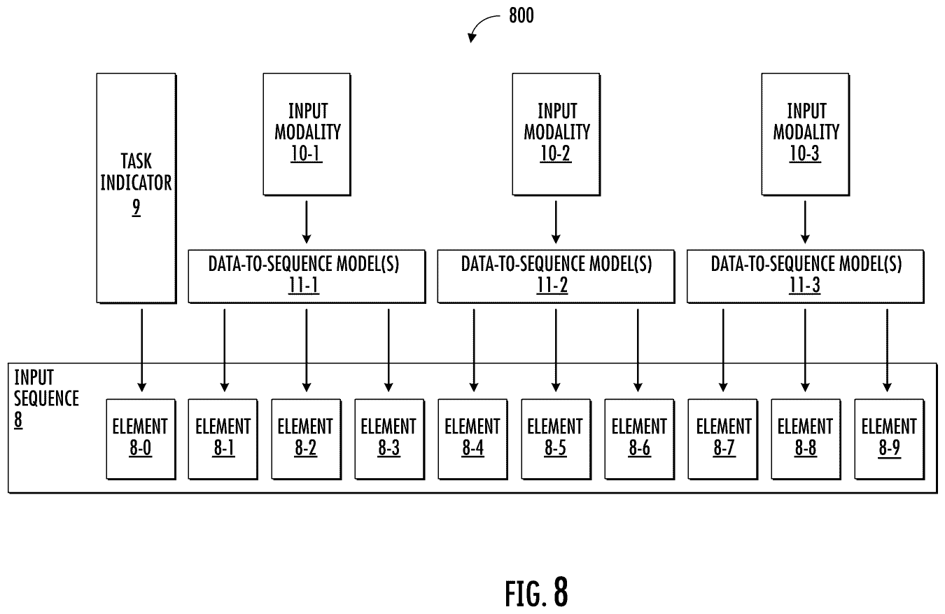

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

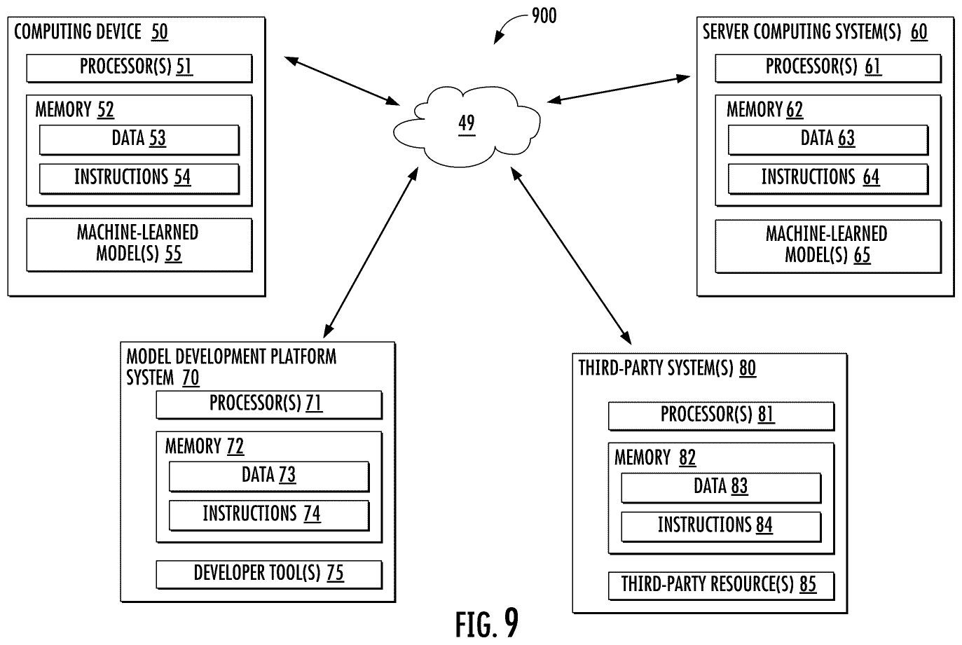

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or intraoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 9 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining, by a computing system, input data comprising a user query and query context data;
processing, by a large language model (LLM) operating on the computing system, the user query and the query context data to generate a set of search results;
defining, by the LLM, a schema associated with a plurality of differentiators based on the user query, the query context data, and the set of search results;
extracting, by the LLM, information associated with the plurality of differentiators from the set of search results;
generating, by the LLM, a comparative data structure using the schema, and the information associated with the plurality of differentiators; and
comparing, by the LLM, the set of search results based on the information associated with the plurality of differentiators using the comparative data structure.

2. The computer-implemented method of claim 1, wherein extracting the information associated with the plurality of differentiators further comprises ranking, by the LLM, each search result within the set of search results based on the information associated with the plurality of differentiators.

3. The computer-implemented method of claim 2, wherein extracting the information associated with the plurality of differentiators further comprises:
selecting, by the LLM, a subset of search results from the set of search results based on the ranking; and
extracting, by the LLM, information associated with the plurality of differentiators from the subset of search results.

4. The computer-implemented method of claim 1, wherein generating the comparative data structure comprises:
initializing, by the LLM, the comparative data structure; and
populating, by the LLM, the comparative data structure with the information associated with the plurality of differentiators.

5. The computer-implemented method of claim 4, wherein generating the comparative data structure comprises grounding, by the computing system, the information associated with the plurality of differentiators using a grounding process.

6. The computer-implemented method of claim 4, wherein generating the comparative data structure comprises normalizing, by the computing system, the information associated with the plurality of differentiators based on the schema.

7. The computer-implemented method of claim 1, wherein generating the comparative data structure comprises:
extracting, by the computing system, image data associated with the set of search results; and
populating, by the computing system, the comparative data structure with the image data.

8. The computer-implemented method of claim 1, wherein the method further comprises generating, by the LLM, a comparative report based on the information associated with each differentiator of the plurality of differentiators.

9. The computer-implemented method of claim 1, wherein processing the user query comprises mapping the user query to a product category based on the query context data.

10. The computer-implemented method of claim 9, wherein mapping the user query to the product category further comprises:
assigning, using the LLM, the user query to at least one query cluster of a plurality of query clusters based on the query context data; and
mapping, using the LLM, the user query to the product category based on the assignment.

11. The computer-implemented method of claim 9, wherein the method further comprises processing, by the computing system, information associated with the product category to identify a plurality of product lines.

12. The computer-implemented method of claim 11, wherein defining the schema associated with the plurality of differentiators further comprises defining the schema based on the plurality of product lines.

13. The computer-implemented method of claim 9, wherein defining the schema associated with the plurality of differentiators comprises identifying, using the LLM, the plurality of differentiators based on the product category and the query context data.

14. The computer-implemented method of claim 13, wherein defining the schema associated with the plurality of differentiators further comprises:
ranking, by the LLM, the plurality of differentiators based on the query context data; and
defining, by the LLM, the schema associated with the plurality of differentiators based on the ranking.

15. The computer-implemented method of claim 1, wherein the method further comprises:
generating, by the computing system, a smart prompt based on the user query, location data associated with a user, and information associated with the plurality of differentiators; and
identifying, by the LLM, the set of search results based on the smart prompt.

16. The computer-implemented method of claim 1, wherein processing the user query comprises comparing the user query to a set of query criteria.

17. The computer-implemented method of claim 1, wherein identifying the set of search results further comprises:
identifying, by the computing system, a first set of search results based on the user query and the query context data;
extracting, by the LLM, information associated with the processed user query from the first set of search results; and
generating, by the computing system, a second set of search results based on the information associated with the processed user query.

18. A computing system, comprising:
one or more processors; and
one or more transitory or non-transitory computer-readable media storing instructions that are executable to cause the one or more processors to perform operations, the operations comprising:
obtaining, by the one or more processors, input data comprising a user query and query context data;
processing, by a large language model (LLM) operating on the one or more processors, the user query and the query context data to generate a set of search results;
defining, by the LLM, a schema associated with a plurality of differentiators based on the user query, the query context data, and the set of search results;
extracting, by the LLM, information associated with the plurality of differentiators from the set of search results;
generating, by the LLM, a comparative data structure using the schema and the information associated with the plurality of differentiators; and
comparing, by the LLM, the set of search results based on the information associated with the plurality of differentiators using the comparative data structure.

19. The computing system of claim 18, wherein processing the user query comprises mapping the user query to a product category based on the query context data.

20. The computing system of claim 19, wherein mapping the user query to the product category further comprises:
assigning, using the LLM, the user query to at least one query cluster of a plurality of query clusters based on the query context data; and
mapping, using the LLM, the user query to the product category based on the assignment.
